(19) United States
(12) Patent Application Publication
(10) Pub. No.: US 2021/0357663 A1
(43) Pub. Date: Nov. 18, 2021

(54) ROAD RECOGNITION DEVICE

(71) Applicant: DENSO CORPORATION, Kariya-city (JP)

(72) Inventors: Masaya OKADA, Nisshin-city (JP); Takumi UEMATSU, Kariya-city (JP)

(21) Appl. No.: 17/387,489

(22) Filed: Jul. 28, 2021

Related U.S. Application Data
(63) Continuation of application No. PCT/JP2020/002485, filed on Jan. 24, 2020.

(30) Foreign Application Priority Data
Jan. 29, 2019 (JP) 2019-012645

(51) Int. Cl. G06K 9/00

(52) U.S. Cl. CPC G06K 9/00798; G05D 1/0231

(57) ABSTRACT

A road recognition device includes a surroundings recognition section recognizing, as surroundings information, at least one of a shape of a roadside object and a travel history of another vehicle, a reliability setting section setting reliability of the surroundings information, a reference line setting section preferentially using surroundings information having higher reliability to determine a reference line of an own lane, and an output section outputting the reference line. When a direction indicator is in operation, the reliability setting section sets reliability of the surroundings information for a direction opposite to a direction indicated by the direction indicator so as to be lower. When the direction indicator is in operation, and the vehicle is traveling in a lane-change prohibition section, the reliability setting section sets reliability of the surroundings information including at least one of the shape of the roadside object and the travel history so as to be lower.

### CROSS-REFERENCE TO RELATED APPLICATION

The present application is based on and claims the benefit of priority from earlier Japanese Patent Application No. 2019-012645 filed on Jan. 29, 2019, the description of which is incorporated herein by reference.

### BACKGROUND

### Technical Field

The present disclosure relates to a road recognition device.

### Related Art

Road recognition devices that determine a reference line of a lane by using lane markings of a road recognized by a camera are known.

### SUMMARY

As an aspect of the present disclosure, a road recognition device for a vehicle having a surroundings sensor is provided. The road recognition device includes a surroundings recognition section that recognizes, as surroundings information, at least one of a shape of a roadside object detected by the surroundings sensor and a travel history of another vehicle; a reliability setting section that sets reliability of the surroundings information; a reference line setting section that preferentially uses the surroundings information having higher reliability to determine a reference line of an own lane in which the vehicle is traveling; and an output section that outputs the reference line. When a direction indicator of the vehicle is in operation, the reliability setting section sets reliability of the surroundings information for a direction opposite to a direction indicated by the direction indicator so as to be lower. When the direction indicator is in operation, and the vehicle is traveling in a lane change prohibition section, the reliability setting section sets reliability of the surroundings information including at least one of the shape of the roadside object and the travel history of the other vehicle so as to be lower.

### BRIEF DESCRIPTION OF THE DRAWINGS

In the accompanying drawings:

FIG. 1 is a schematic diagram illustrating a configuration of an autonomous driving system;

FIG. 2 is a flowchart of a road recognition process;

FIG. 3 is a flowchart of a reliability setting process;

FIG. 4 illustrates an example of a reference line;

FIG. 5 is a flowchart of a reference line setting process;

FIG. 6 is a diagram for describing merging support;

FIG. 7 is a flowchart of a reliability setting process according to a second embodiment;

FIG. 8 illustrates an example of lines;

FIG. 9 is a flowchart of a reference line setting process according to the second embodiment;

FIG. 10 is a flowchart of a reliability setting process according to a third embodiment; and

FIG. 11 illustrates another example of lines.

### DETAILED DESCRIPTION OF THE PREFERRED EMBODIMENTS

Road recognition devices that determine a reference line of a lane by using lane markings of a road recognized by a camera are known. For example, autonomous vehicles can automatically travel along a reference line. Japanese Patent No. 3871772 discloses a technique in which, at a merging point, a course along a traveling lane is determined by using a lane marking present in the direction opposite to the direction that a direction indicator indicates.

However, for example, in a merging lane merging into a main lane, if a reference line is determined by using a lane marking present in the direction opposite to the direction that a direction indicator indicates, the reference line may curve along the lane marking to enter the main lane. In this case, if the vehicle travels along the reference line, the vehicle may unintentionally enter the main lane without being controlled for the merging. Hence, a technique for appropriately determining a reference line is desired.

### A. First Embodiment

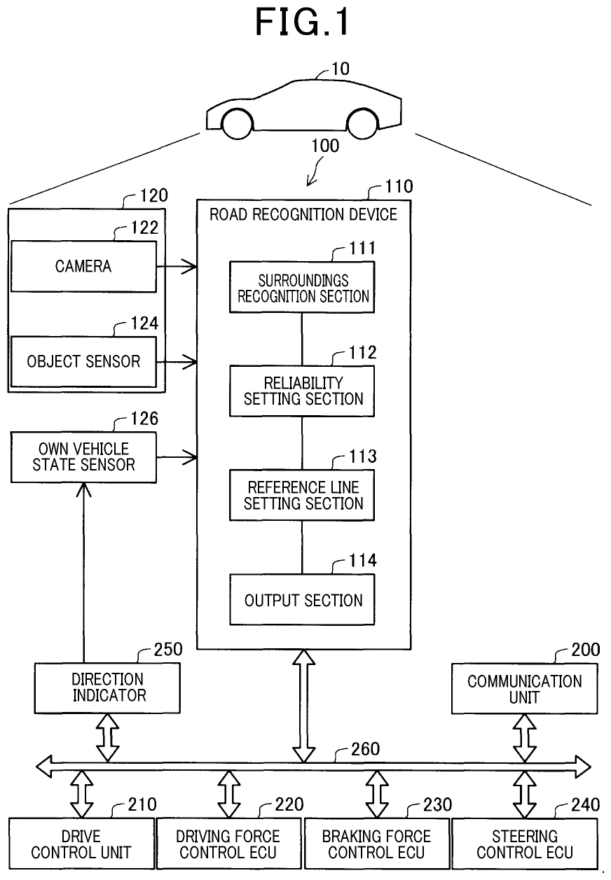

As shown in FIG. 1, a vehicle 10 includes an autonomous driving control system 100. In the present embodiment, the autonomous driving control system 100 includes a road recognition device 110, a surroundings sensor 120, an own vehicle state sensor 126, a drive control unit 210, a driving force control ECU (Electronic Control Unit) 220, a braking force control ECU 230, a steering control ECU 240, and a direction indicator 250. The road recognition device 110, the drive control unit 210, the driving force control ECU 220, the braking force control ECU 230, the steering control ECU 240, and the direction indicator 250 are connected via an in-vehicle network 260.

The road recognition device 110 includes a surroundings recognition section 111, a reliability setting section 112, a reference line setting section 113, and an output section 114. The road recognition device 110 is configured by a microcomputer including a central processing unit (CPU), a RAM, and a ROM, and the like. The microcomputer executes a previously installed program to implement functions of these sections. Some or all of the functions of these sections may be implemented by hardware circuits.

The surroundings recognition section 111 recognizes surroundings information by using detection signals from the surroundings sensor 120. More specifically, the surroundings recognition section 111 recognizes, as the surroundings information, a shape of a lane marking of a road detected by the surroundings sensor 120, a shape of a roadside object, and a travel history of another vehicle. The reliability setting section 112 sets reliability of the surroundings information. The reference line setting section 113 preferentially uses the surroundings information having higher reliability to determine a reference line of a lane in which the vehicle 10 is traveling. The reference line is, for example, a center line of a lane. The vehicle 10 can automatically travel along the reference line. The reference line setting section 113 determines a reference line by displacing a line, which is obtained from a shape of a lane marking or a roadside object or a sequence of points representing a travel history of another vehicle, to the center of the lane. For example, when a shape of a lane marking is used, the reference line setting section 113 determines a reference line by displacing the line determined from the shape of the lane marking by half of the width of the lane. The output section 114 outputs the reference line determined by the reference line setting section 113 to the drive control unit 210 and the like through the in-vehicle network 260.

The surroundings sensor 120 includes a camera 122 and an object sensor 124. The camera 122 images the surroundings of the own vehicle to obtain images. The object sensor 124 detects a state of the surroundings of the own vehicle. As the object sensor 124, for example, a sensor utilizing reflected waves such as a laser radar, a millimeter-wave radar, and an ultrasonic sensor may be used. In the present embodiment, the surroundings recognition section 111 detects lane markings on the right and left sides of the road on which the vehicle is traveling and the locations of the lane markings, a roadside object and the location thereof, another vehicle and the location, size, distance, traveling direction, speed, and yaw angular velocity thereof, and the like. The surroundings recognition section 111 may detect part or all of the information through inter-vehicle communication with another vehicle.

The own vehicle state sensor 126 includes a vehicle sensor and a yaw rate sensor. The own vehicle state sensor 126 detects, as a state of the vehicle 10, a velocity of the vehicle 10, whether the direction indicator 250 is in operation, and a yaw rate.

The drive control unit 210 is configured by a microcomputer including a central processing unit (CPU), a RAM, and a ROM, or the like. The microcomputer executes a previously installed program to implement an autonomous driving function. The drive control unit 210 controls the driving force control ECU 220, the braking force control ECU 230, and the steering control ECU 240 so that, for example, the vehicle 10 travels along the reference line determined by the reference line setting section 113. For example, when the vehicle 10 makes a lane change to an adjacent lane, the drive control unit 210 may perform merging support so that the vehicle 10 travels from the reference line of the lane, in which the vehicle 10 is traveling, to the reference line of the adjacent lane. In addition, the drive control unit 210 controls operation of the direction indicator 250.

The driving force control ECU 220 is an electronic control unit that controls an actuator such as an engine generating driving force of the vehicle. When a driver manually drives the vehicle, the driving force control ECU 220 controls a power source, which is an engine or an electrical motor, depending on the amount of operation of an accelerator pedal. In contrast, when autonomous driving is performed, the driving force control ECU 220 controls the power source depending on required driving force calculated by the drive control unit 210.

The braking force control ECU 230 is an electronic control unit that controls a brake actuator generating braking force of the vehicle. When the driver manually drives the vehicle, the braking force control ECU 230 controls the brake actuator depending on the amount of operation of a brake pedal. In contrast, when autonomous driving is performed, the braking force control ECU 230 controls the brake actuator depending on required braking force calculated by the drive control unit 210.

The steering control ECU 240 is an electronic control unit that controls a motor generating steering torque of the vehicle. When the driver manually drives the vehicle, the steering control ECU 240 controls the motor depending on the operation of a steering wheel to generate assist torque for the operation of the steering wheel. Hence, the driver can operate the steering wheel with small force, which implements steering of the vehicle. In contrast, when autonomous driving is performed, the steering control ECU 240 controls the motor depending on a required steering angle calculated by the drive control unit 210 to perform steering.

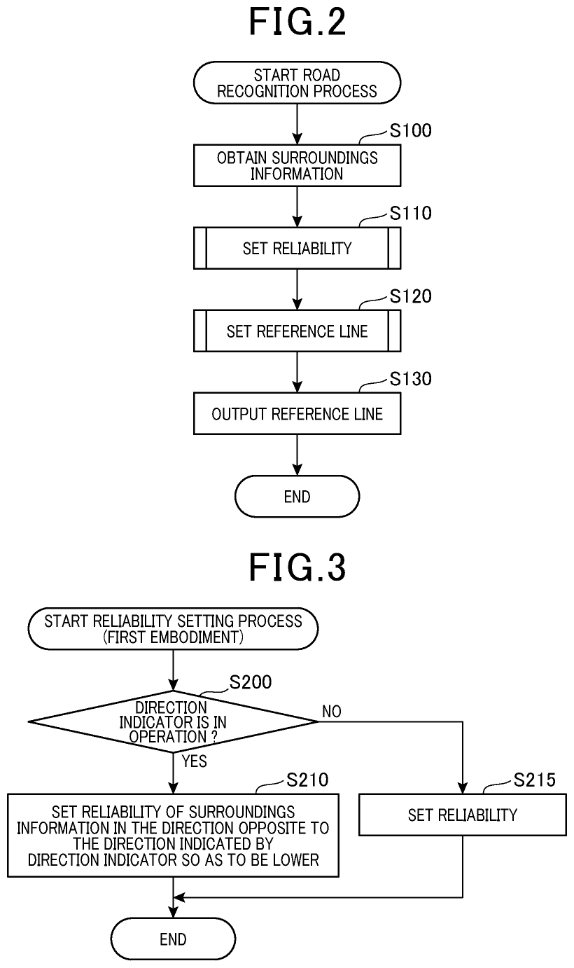

The road recognition process shown in FIG. 2 is a series of processing in which the reference line setting section 113 determines a reference line of a lane in which the vehicle 10 travels. This process is repeatedly performed by the road recognition device 110, for example, every 100 ms, while the vehicle 10 is traveling.

First, in step S100, the surroundings recognition section 111 acquires surroundings information. More specifically, the surroundings recognition section 111 acquires surroundings information from images of the surroundings of the vehicle 10 captured by the camera 122 or a state of the surroundings of the vehicle 10 detected by the object sensor 124.

Next, in step S110, the reliability setting section 112 sets reliability of the surroundings information acquired in step S100. In the present embodiment, the reliability setting section 112 sets reliability of, as the surroundings information, (1) a shape of a lane marking of a road, (2) a shape of a roadside object, and (3) a travel history of another vehicle. The setting of the reliability will be described later in detail.

Next, in step S120, the reference line setting section 113 preferentially uses the surroundings information having higher reliability set in step S110 to determine a reference line of an own lane in which the vehicle 10 is traveling and a reference line of an adjacent lane. The determination of the reference lines will be described later in detail.

Finally, in step S130, the output section 114 outputs the reference lines determined in step S120 to the drive control unit 210.

The reliability setting process shown in FIG. 3 is a series of processing in which the reliability setting section 112 sets reliability of the surroundings information. In step S200, the reliability setting section 112 determines whether the direction indicator 250 of the vehicle 10 is in operation. If a predetermined time period has not elapsed from when the operation of the direction indicator 250 is finished, the reliability setting section 112 may determine that the direction indicator 250 is in operation. When the direction indicator 250 is in operation, the reliability setting section 112 proceeds to step S210, in which the reliability setting section 112 sets reliability of the surroundings information for the direction opposite to the direction indicated by the direction indicator 250 so as to be lower (the reliability setting section 112 reduces the reliability of the surroundings information for the direction opposite to the direction indicated by the direction indicator 250). In contrast, when the direction indicator 250 is not in operation, the reliability setting section 112 proceeds to step S215, in which the reliability setting section 112 sets reliability. In steps S210 and S215, for example, the reliability setting section 112 sets lower reliability as the distance from the vehicle 10 to the location at which the surroundings information is acquired is longer. In addition, for example, the reliability setting section 112 sets reliability of a shape of a lane marking so as to be higher than reliability of a travel history of another vehicle and reliability of a shape of a roadside object.

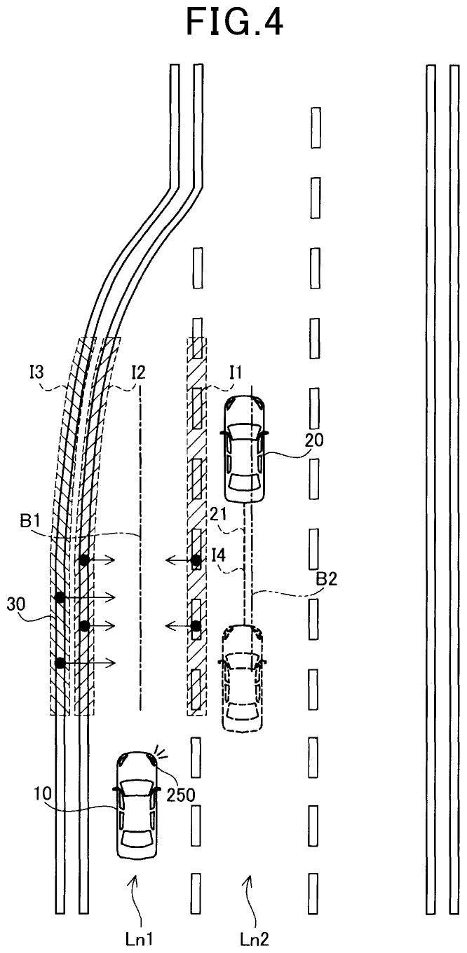

As shown in FIG. 4, the vehicle 10 is traveling in a lane Ln1, which is a merging lane, and another vehicle 20 is traveling in a lane Ln2, which is a lane adjacent to the lane Ln1 (adjacent lane). A reference line B1 is determined by using a shape of a lane marking of the lane Ln1, a shape of a roadside object 30, and a travel history 21 of the other vehicle 20. For the sake of convenience, surroundings information I1 to 13 is shown as hatched areas. The surroundings information I1 indicates a shape of a lane marking of the lane Ln1 present in the direction indicated by operation of the direction indicator 250 of the vehicle 10. The surroundings information 12 indicates a shape of a lane marking of the lane Ln1 present in the direction opposite to the direction indicated by the direction indicator 250 of the vehicle 10. The surroundings information 13 indicates a shape of the roadside object 30 present in the direction opposite to the direction indicated by the direction indicator 250 of the vehicle 10. The travel history 21 is also referred to as surroundings information 14. The surroundings information 14 is the travel history 21 of the other vehicle 20 traveling in the adjacent lane Ln2 present in the direction indicated by the direction indicator 250 of the vehicle 10 in the lane Ln1. In step S210 (FIG. 3), the reliability setting section 112 sets reliability of the surroundings information 12 and 13 for the direction opposite to the direction indicated by the direction indicator 250 of the vehicle 10 so as to be lower than the reliability of the surroundings information I1 and 14 in the direction indicated by the direction indicator 250 of the vehicle 10.

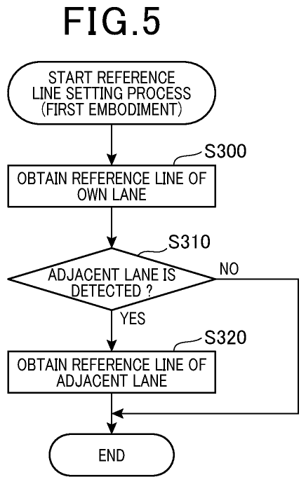

The reference line setting process shown in FIG. 5 is a series of processing in which the reference line setting section 113 determines a reference line in step S120 shown in FIG. 2. First, in step S300, the reference line setting section 113 preferentially uses the surroundings information having higher reliability to determine a reference line B1 of an own lane Ln1 in which the vehicle 10 is traveling. Referring to FIG. 4, the reference line setting section 113 uses the surroundings information I1 and 14 having higher reliability in preference to the surroundings information 12 and 13 having lower reliability to determine the reference line B1 of the own lane Ln1. More specifically, for example, the reference line setting section 113 can determine the reference line B1 by displacing lines determined from the surroundings information I1 to 14 to the center of the lane Ln1 and weighted-averaging the lines depending on reliability, that is, so that weight is greater as the reliability is higher. Hence, the reference line B1 can be prevented from curving toward the lane Ln2 as in the shape of the lane marking of the lane Ln1 present in the direction opposite to the direction indicated by the direction indicator 250 of the vehicle 10 or the shape of the roadside object 30. The reference line setting section 113 may determine the reference line B1 by using only the surroundings information having reliability equal to or more than a predetermined threshold.

Next, in step S310, the reference line setting section 113 determines whether the adjacent lane Ln2 has been detected. Detecting the adjacent lane Ln2 uses surroundings information. For example, if the other vehicle 20 traveling in the same direction as the traveling direction of the vehicle 10 is recognized next to the vehicle 10 in the image picked up by the camera 122, the adjacent lane Ln2 is detected. If the adjacent lane Ln2 has not been detected, the reference line setting section 113 ends the reference line setting process. In contrast, if the adjacent lane Ln2 has been detected, the reference line setting section 113 proceeds to step S320, in which the reference line setting section 113 uses the reference line B1 of the own lane Ln1 to determine a reference line B2 of the adjacent lane Ln2. The reference line B2 of the adjacent lane Ln2 is determined by, for example, displacing the reference line B1 of the own lane Ln1 to the adjacent lane by the width of the lane Ln1.

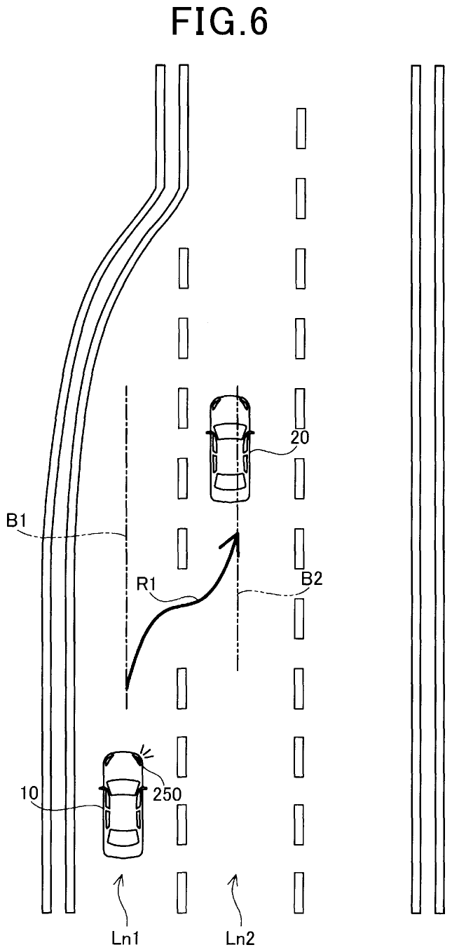

As shown in FIG. 6, the drive control unit 210 controls the ECUs by using the reference lines B1 and B2 output from the output section 114 so that the vehicle travels on a route R1, thereby performing merging support associated with a lane change. The route R1 is a curve smoothly connecting the reference line B1 of the own lane Ln1 and the reference line B2 of the adjacent lane Ln2.

According to the road recognition device 110 of the present embodiment described above, when the direction indicator 250 is in operation, the reliability setting section 112 lowers the reliability of the surroundings information 12 and 13 for the direction opposite to the direction indicated by the direction indicator 250. The reference line setting section 113 preferentially uses the surroundings information I1 having higher reliability to determine the reference line B1. Hence, for example, the reference line can be prevented from curving along the lane marking in a merging lane, which merges into a main lane, and entering the main lane, whereby the reference line B1 can be appropriately determined.

The reference line setting section 113 determines the reference line B1 by using, in addition to a shape of a lane marking of a road, a shape of the roadside object 30 such as a wall or a guardrail and the travel history 21 of the other vehicle 20. Hence, even when the shape of the lane marking cannot be recognized, the reference line B1 can be determined. In addition, since the shape of the roadside object 30 or the travel history 21 of the other vehicle 20 can be used to recognize a longer distance than the lane marking of the road that is used, using the combination of the shape of the roadside object 30 or the travel history 21 of the other vehicle 20 and the lane marking of the road can determine a longer reference line B1 with high accuracy.

The reference line setting section 113 determines, in addition to the reference line B1 of the own lane Ln1, the reference line B2 of the adjacent lane Ln2. Hence, when a lane change is made, merging support for traveling along a route connecting the reference line B1 of the own lane Ln1 and the reference line B2 of the adjacent lane Ln2 can be performed.

### B. Second Embodiment

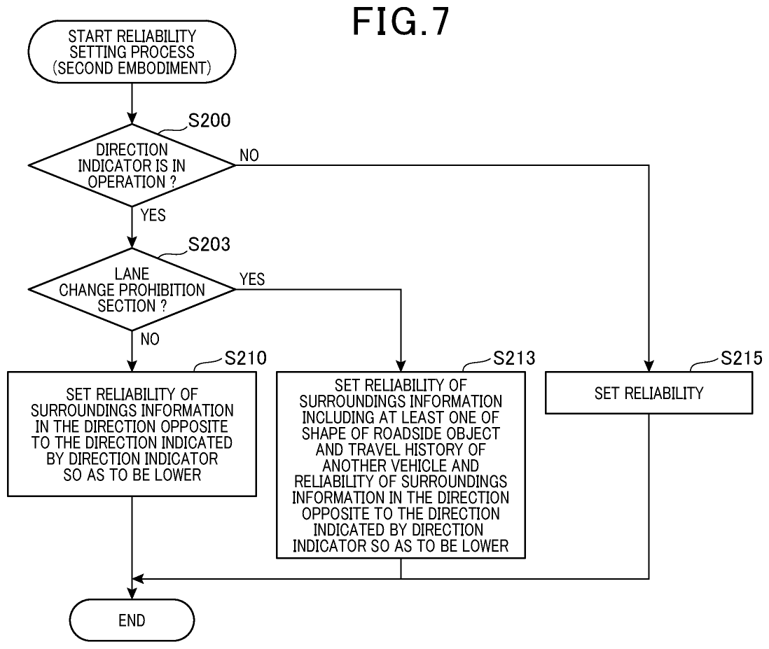

A reliability setting process according to the second embodiment shown in FIG. 7 differs from the reliability setting process of the first embodiment shown in FIG. 3 in that reliability is set depending on whether there is a section where a lane change is prohibited (lane change prohibition section). Since the configuration of an autonomous driving control system of the second embodiment is identical to the configuration of the autonomous driving control system of the first embodiment, description of the autonomous driving control system is omitted.

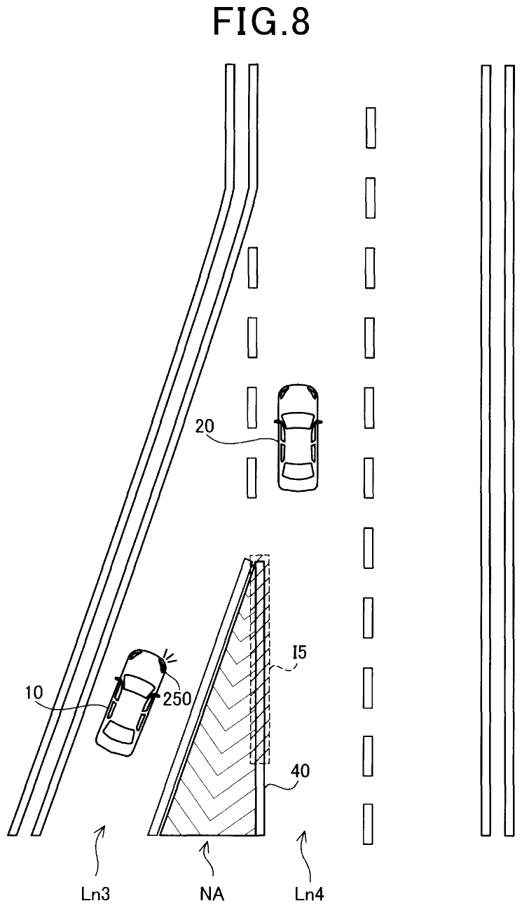

As shown in FIG. 8, the vehicle 10 is traveling in a lane Ln3, which is a merging lane, and a no-entry area NA is provided between the lane Ln3 and a lane Ln4 adjacent to the lane Ln3. For the sake of convenience, surroundings information 15 is shown as hatched areas. The surroundings information 15 indicates, for example, a shape of a roadside object 40 such as a guardrail, which is provided on the adjacent lane Ln4 side of the no-entry area NA and indicates a lane change prohibition section.

In the second embodiment, if it is determined that the direction indicator 250 is in operation in step S200 (FIG. 7), in step s203, the reliability setting section 112 determines whether the lane Ln3 in which the vehicle is traveling is a lane change prohibition section. The reliability setting section 112 makes the determination by using surroundings information. For example, if a traffic sign indicating no-entry or a zebra zone (zebra crossing) is recognized in an image captured by the camera 122, the reliability setting section 112 determines that the lane Ln3 is a lane change prohibition section. The reliability setting section 112 may obtain information on whether there is a lane change prohibition section from a navigation system or the like. If it is determined that the lane Ln3 is not a lane change prohibition section, the reliability setting section 112 proceeds to step S210, in which the reliability setting section 112 sets reliability of the surroundings information for the direction opposite to the direction indicated by the direction indicator 250 so as to be lower. In contrast, if it is determined that the lane Ln3 is a lane change prohibition section, the reliability setting section 112 proceeds to step S213, in which the reliability setting section 112 sets, in addition to the reliability of the surroundings information for the direction opposite to the direction indicated by the direction indicator 250, reliability of the surroundings information including at least one of a shape of a roadside object and a travel history of another vehicle so as to be lower. Referring to FIG. 8, the reliability setting section 112 sets the reliability of the surroundings information 15 so as to be lower.

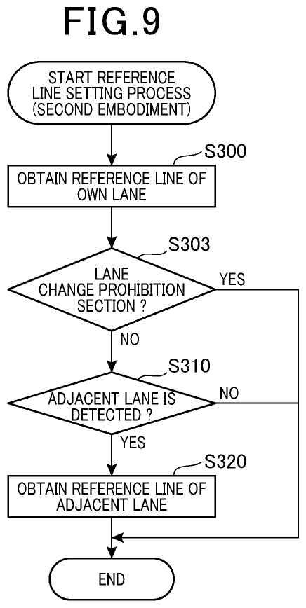

A reference line setting process according to the second embodiment shown in FIG. 9 differs from the reference line setting process of the first embodiment shown in FIG. 5 in that a reference line of the adjacent lane Ln4 is not determined if a lane change prohibition section is detected.

In the second embodiment, after step S300, in step S303, the reference line setting section 113 determines whether the road on which the vehicle 10 is traveling is a lane change prohibition section. The reference line setting section 113 may obtain the result of the determination whether the road on which the vehicle 10 is traveling is a lane change prohibition section in step S203 from the reliability setting section 112. If it is determined that the road on which the vehicle 10 is traveling is not a lane change prohibition section, the reference line setting section 113 proceeds to step S310, in which if an adjacent lane is detected, in step S320, the reference line setting section 113 determines a reference line of the adjacent lane Ln4. In contrast, if it is determined that the road on which the vehicle 10 is traveling is a lane change prohibition section, the reference line setting section 113 ends the reference line setting process, that is, the reference line setting section 113 does not determine a reference line of the adjacent lane Ln4.

According to the road recognition device 110 of the present embodiment described above, when the direction indicator 250 is in operation, and the vehicle 10 is traveling in a lane change prohibition section, the reliability setting section 112 sets, in addition to the reliability of the surroundings information for the direction opposite to the direction indicated by the direction indicator 250, the reliability of the surroundings information including at least one of a shape of a roadside object and a travel history of another vehicle so as to be lower. The reason is that, for example, in a lane change prohibition section, since the own lane Ln3 and the adjacent lane Ln4 may not be parallel, if a reference line of the own lane Ln3 is determined by using a travel history of another vehicle that is traveling in the adjacent lane Ln4 or a shape of a roadside object indicating a lane change prohibition section, the reference line may be different from the actual shape of the lane. Hence, according to the present embodiment, the reference line can be determined more appropriately.

In the present embodiment, when the vehicle 10 is traveling in the lane change prohibition section, the reference line setting section 113 does not determine a reference line of an adjacent lane. The reason is that, for example, in the lane change prohibition section, since the own lane Ln3 and the adjacent lane Ln4 may not be parallel, a reference line of the adjacent lane Ln4 having a shape different from the actual shape of the lane may be determined. Hence, according to the present embodiment, a reference line of the adjacent lane Ln4 having a shape different from the actual shape of the lane can be prevented from being determined. Since merging support associated with a lane change is not performed in the lane change prohibition section, the travel is not affected even when a reference line of the adjacent lane Ln4 is not determined.

### C. Third Embodiment

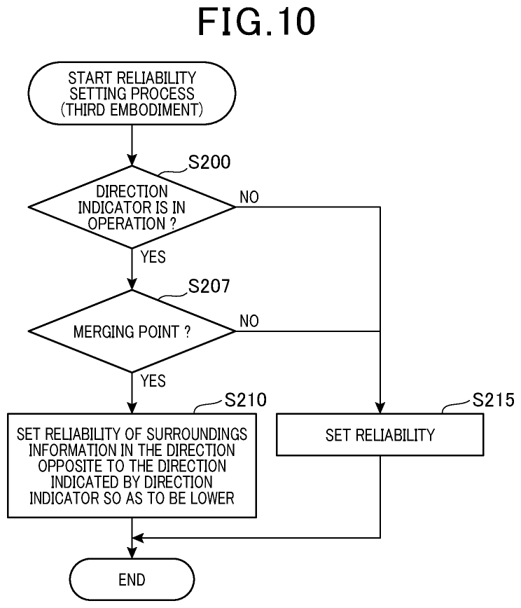

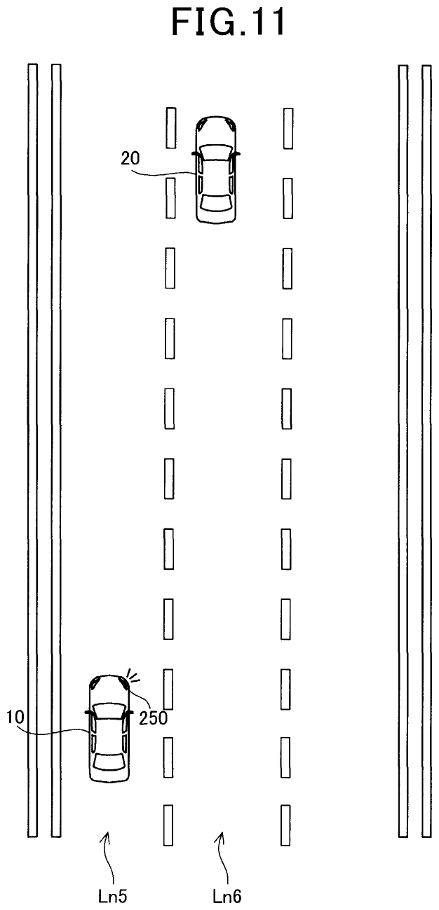

A road recognition process according to the third embodiment shown in FIG. 10 differs from the road recognition process of the first embodiment shown in FIG. 3 in that reliability is set depending on whether there is a merging point. Since the configuration of an autonomous driving control system of the third embodiment is identical to the configuration of the autonomous driving control system of the first embodiment, description of the autonomous driving control system is omitted.

As shown in FIG. 11, the vehicle 10 is traveling in a lane Ln5, and the lane Ln5 and a lane Ln6 adjacent to the lane Ln5 are parallel without merging. That is, the road shown in FIG. 11 differs from the roads having a merging point shown in FIG. 4 and FIG. 8, and does not have a merging point.

In the third embodiment, if it is determined that the direction indicator 250 is in operation in step S200 (FIG. 10), in step S207, the reliability setting section 112 determines whether a merging point has been detected. In the present embodiment, the reliability setting section 112 detects a merging point by using surroundings information. For example, the reliability setting section 112 detects, as a merging point, a point where the distance between right and left lane markings indicating a lane in which the vehicle 10 is traveling becomes narrow in an image captured by the camera 122 or a point where the distance between a lane marking in the right direction from the vehicle 10 and a roadside object in the left direction from the vehicle 10 becomes narrow in the image. The reliability setting section 112 may obtain information on whether there is a merging point from a navigation system or the like. When a merging point has been detected, the reliability setting section 112 proceeds to step S210, in which the reliability setting section 112 sets reliability of the surroundings information for the direction opposite to the direction indicated by the direction indicator 250 so as to be lower. It is noted that at a merging point, another vehicle traveling ahead of the own vehicle in a lane in which the own vehicle travels is likely to make a lane change. Hence, it is preferable to set reliability of a travel history of another vehicle traveling ahead of the own vehicle in a lane in which the own vehicle travels so that the travel history is not used when the reference line setting section 113 determines a reference line. Whether another vehicle is traveling ahead of the own vehicle can be determined from, for example, an image captured by the camera 122 or a detection result of the object sensor 124. In contrast, as in the state shown in FIG. 11, if a merging point has not been detected, the reliability setting section 112 proceeds to step S215, in which reliability is set as in the first embodiment.

According to the road recognition device 110 of the present embodiment described above, when the direction indicator 250 is in operation and a merging point has been detected, the reliability setting section 112 sets reliability of the surroundings information for the direction opposite to the direction indicated by the direction indicator 250 so as to be lower. That is, even when the direction indicator 250 is in operation, if no merging point is detected, reliability of the surroundings information for the direction opposite to the direction indicated by the direction indicator 250 is not lowered. Hence, in the lane Ln5 in which no merging point is detected, the surroundings information for the direction opposite to the direction indicated by the direction indicator 250 can be prevented from being not used in excess (can be used as much as possible).

### D. Other Embodiments

(D1) In the above embodiment, the reference line setting section 113 determines a reference line by using a shape of a lane marking or a roadside object or a travel history of another vehicle as surroundings information. Alternatively, the reference line setting section 113 may obtain a reference line by using not only the surroundings information but also a reference line, which is calculated by another vehicle, obtained through inter-vehicle communication with the other vehicle. For example, the reference line setting section 113 displaces a reference line calculated by another vehicle that is traveling in an adjacent lane by the width of the lane, displaces a line obtained from a shape of a lane marking to the center of an own lane, and average the lines, to obtain a reference line.

(D2) In the above embodiment, the output section 114 outputs a reference line obtained by the reference line setting section 113 to the drive control unit 210. Alternatively, the output section 114 may output the reference line to a road model calculation section that calculates a road model representing a road shape by lines more preciously than a reference line. The road model calculation section can calculate a road model by using, for example, a Kalman filter or a least square method based on the surroundings information or the reference line. In this case, the drive control unit 210 controls the ECUs so that the vehicle travels along the road model calculated by the road model calculation section.

(D3) In the above first embodiment, when the adjacent lane Ln2 is present, the reference line setting section 113 detects a reference line of the adjacent lane Ln2 by the reference line setting process shown in FIG. 3. Alternatively, the reference line setting section 113 may omit the processing (steps S310 and S320) and determine and output only the reference line of the own lane.

The present disclosure is not limited to the above embodiments and can be implemented by various configurations within a scope not deviating from the gist of the present disclosure.

The control section and the method thereof of the present disclosure may be implemented by a dedicated computer provided by configuring a processor programmed to execute one or more functions embodied by computer programs and a memory. Alternatively, the control section and the method thereof described in the present disclosure may be implemented by a dedicated computer provided by configuring a processor by one or more dedicated hardware logic circuits. Alternatively, the control section and the method thereof described in the present disclosure may be implemented by one or more dedicated computers configured by combining a processor programmed to execute one or more functions and a memory, with a processor configured by one or more hardware logic circuits. The computer programs may be stored in a computer-readable non-transitional tangible storage medium as instructions executed by the computer.

According to the present disclosure, a road recognition device (110) for a vehicle (10) having a surroundings sensor (120) is provided. The road recognition device includes a surroundings recognition section (111) that recognizes, as surroundings information, at least one of a shape of a roadside object detected by the surroundings sensor and a travel history of another vehicle; a reliability setting section (112) that sets reliability of the surroundings information; a reference line setting section (113) that preferentially uses the surroundings information having higher reliability to determine a reference line of an own lane in which the vehicle is traveling; and an output section (114) that outputs the reference line. When a direction indicator (250) of the vehicle is in operation, the reliability setting section sets reliability of the surroundings information for a direction opposite to a direction indicated by the direction indicator so as to be lower. When the direction indicator is in operation, and the vehicle is traveling in a lane change prohibition section, the reliability setting section sets reliability of the surroundings information including at least one of the shape of the roadside object and the travel history of the other vehicle so as to be lower.

According to the above road recognition device, when the direction indicator is in operation, since reliability of the surroundings information for a direction opposite to a direction indicated by the direction indicator is lowered, a reference line can be determined appropriately.

What is claimed is:

1. A road recognition device for a vehicle having a surroundings sensor, the device comprising:
a surroundings recognition section that recognizes, as surroundings information, at least one of a shape of a roadside object detected by the surroundings sensor and a travel history of another vehicle;
a reliability setting section that sets reliability of the surroundings information;
a reference line setting section that preferentially uses the surroundings information having higher reliability to determine a reference line of an own lane in which the vehicle is traveling; and
an output section that outputs the reference line, wherein
when a direction indicator of the vehicle is in operation, the reliability setting section sets reliability of the surroundings information for a direction opposite to a direction indicated by the direction indicator so as to be lower, and
when the direction indicator is in operation, and the vehicle is traveling in a lane change prohibition section, the reliability setting section sets reliability of the surroundings information including at least one of the shape of the roadside object and the travel history of the other vehicle so as to be lower.

2. The road recognition device according to claim 1, wherein
the reference line setting section determines a reference line of a lane adjacent to the own lane by using the reference line of the own lane.

3. The road recognition device according to claim 2, wherein
when the vehicle is traveling in the lane change prohibition section, the reference line setting section does not determine a reference line of the lane adjacent to the own lane.

4. The road recognition device according to claim 1, wherein
when the direction indicator is in operation, and a merging point is determined, the reliability setting section sets reliability of the surroundings information for a direction opposite to a direction indicated by the direction indicator so as to be lower.

5. A road recognition device for a vehicle having a surroundings sensor, the device comprising:
a surroundings recognition section that recognizes, as surroundings information, at least one of a shape of a lane marking of a road detected by the surroundings sensor, a shape of a roadside object, and a travel history of another vehicle;
a reliability setting section that sets reliability of the surroundings information;
a reference line setting section that preferentially uses the surroundings information having higher reliability to determine a reference line of an own lane in which the vehicle is traveling; and
an output section that outputs the reference line, wherein
when a direction indicator of the vehicle is in operation, the reliability setting section sets reliability of the surroundings information for a direction opposite to a direction indicated by the direction indicator so as to be lower, and
the reference line setting section determines a reference line of a lane adjacent to the own lane by using the reference line of the own lane.

6. A road recognition device for a vehicle having a surroundings sensor, the device comprising:
a surroundings recognition section that recognizes, as surroundings information, at least one of a shape of a lane marking of a road detected by the surroundings sensor, a shape of a roadside object, and a travel history of another vehicle;
a reliability setting section that sets reliability of the surroundings information;
a reference line setting section that preferentially uses the surroundings information having higher reliability to determine a reference line of an own lane in which the vehicle is traveling; and
an output section that outputs the reference line, wherein
when a direction indicator of the vehicle is in operation, the reliability setting section sets reliability of the surroundings information for a direction opposite to a direction indicated by the direction indicator so as to be lower, and
when the direction indicator is in operation, and a merging point is determined, the reliability setting section sets reliability of the surroundings information for a direction opposite to a direction indicated by the direction indicator so as to be lower.
